(19) United States
(12) Patent Application Publication
(10) Pub. No.: US 2009/0051177 A1
(43) Pub. Date: Feb. 26, 2009

(54) Bumper Guide with Illumination Performance

(76) Inventors: Ming-Cheng Wang, Yung Kang City (TW); Kai-Yu Wang, Yung Kang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/842,471

(22) Filed: Aug. 21, 2007

(51) Int. Cl. B60R 19/48

(52) U.S. Cl. 293/117

(57) ABSTRACT

A guide for the vehicle includes a main body and a light emitting device mounted in the main body. The main body includes a support tube to support the light emitting device, a connecting member mounted on the support tube, a mounting sleeve mounted on the connecting member, and a housing mounted on the mounting sleeve and juxtaposed to the connecting member to retain the light emitting device between the housing and the connecting member. Thus, the guide has a light emitting device that emits light outwardly to provide a warning effect at the night or on a darker place so as to provide the driver's safety.

### BACKGROUND OF THE INVENTION

1. Field of the Invention

The present invention relates to a guide for the vehicle and, more particularly, to a bumper guide mounted on the front side of the vehicle.

2. Description of the Related Art

A conventional bumper guide is mounted on the front side of the vehicle to provide a locating function or an ornament function. However, the bumper guide only has a single function, thereby limiting the versatility of the bumper guide.

### BRIEF SUMMARY OF THE INVENTION

In accordance with the present invention, there is provided a guide, comprising a main body and a light emitting device mounted in the main body. The main body includes a support tube to support the light emitting device, a connecting member mounted on the support tube, a mounting sleeve mounted on the connecting member, and a housing mounted on the mounting sleeve and juxtaposed to the connecting member to retain the light emitting device between the housing and the connecting member.

The primary objective of the present invention is to provide the vehicle bumper guide with illumination performance.

Another objective of the present invention is to provide a guide for the vehicle, wherein the guide comprises a light emitting device that emits light outwardly to provide a warning effect at the night or on a darker place so as to provide the driver's safety.

Further benefits and advantages of the present invention will become apparent after the careful reading of the detailed description with appropriate reference to the accompanying drawings.

### BRIEF DESCRIPTION OF THE SEVERAL VIEWS OF THE DRAWING(S)

FIG. 1 is a perspective view of a guide in accordance with the preferred embodiment of the present invention.

FIG. 2 is an exploded perspective view of the guide as shown in FIG. 1.

FIG. 3 is a front cross-sectional view of the guide as shown in FIG. 1.

FIG. 4 is a perspective view of a guide in accordance with another preferred embodiment of the present invention.

FIG. 5 is a front cross-sectional view of the guide as shown in FIG. 4.

### DETAILED DESCRIPTION OF THE INVENTION

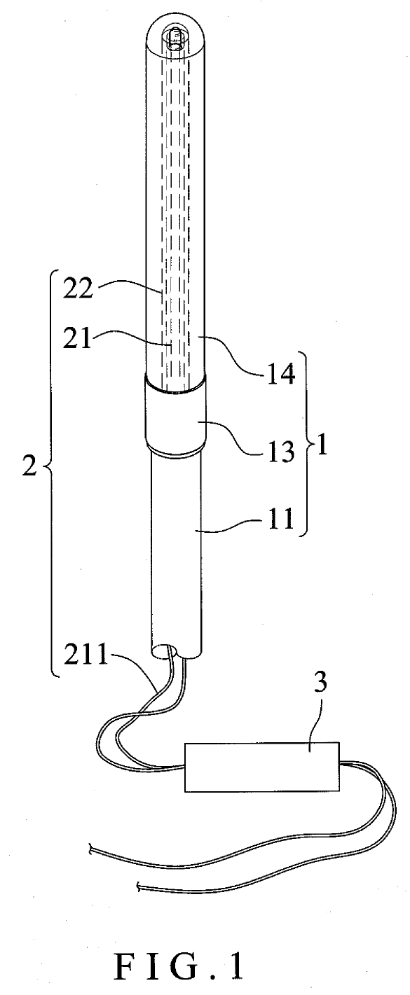

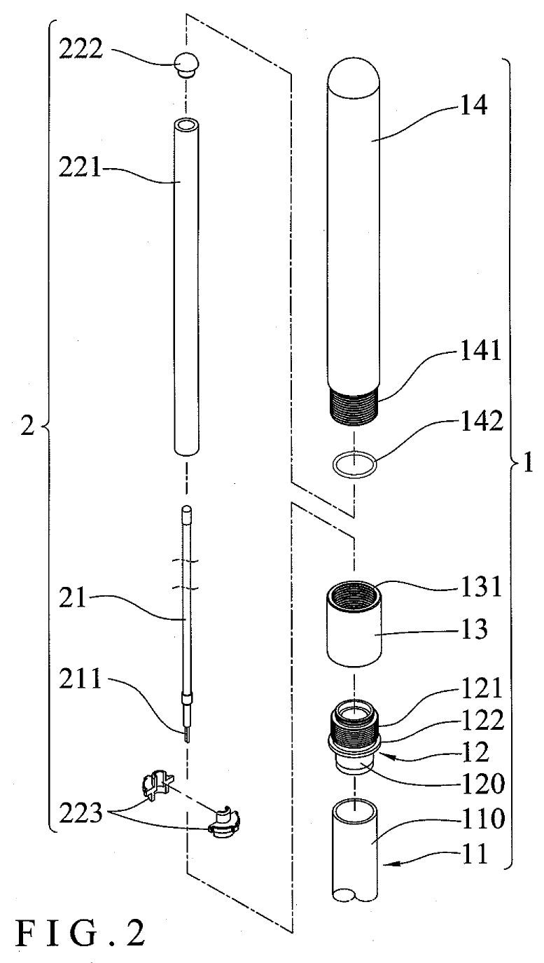

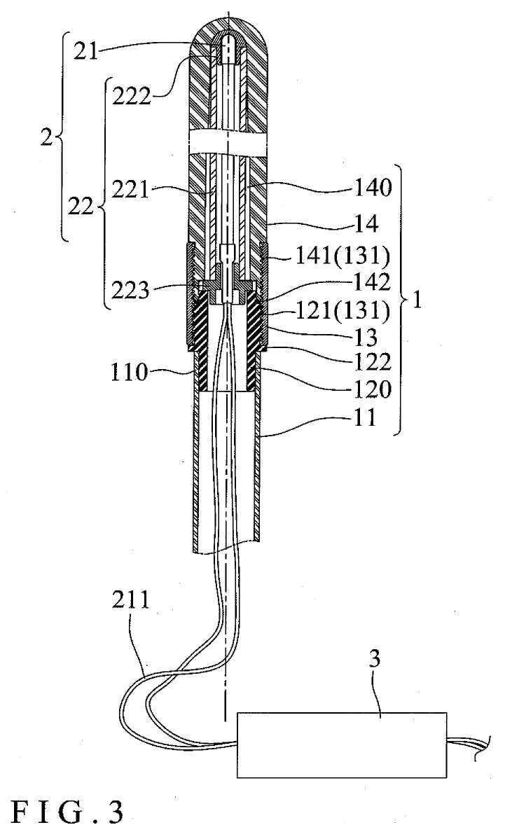

Referring to the drawings and initially to FIGS. 1-3, a guide for the vehicle in accordance with the preferred embodiment of the present invention comprises a main body 1 and a light emitting device 2 mounted in the main body 1.

The main body 1 includes a support tube 11 to support the light emitting device 2, a connecting member 12 mounted on the support tube 11, a mounting sleeve 13 mounted on the connecting member 12, and a housing 14 mounted on the mounting sleeve 13 and juxtaposed to the connecting member 12 to retain the light emitting device 2 between the housing 14 and the connecting member 12.

The support tube 11 of the main body 1 has two open ends.

The mounting sleeve 13 of the main body 1 connects the connecting member 12 and the housing 14. The mounting sleeve 13 of the main body 1 has an inside formed with an inner threaded portion 131 which extends a whole length of the mounting sleeve 13 of the main body 1.

The connecting member 12 of the main body 1 connects the support tube 11 and the mounting sleeve 13. The connecting member 12 of the main body 1 has a tubular shape and has a lower end 120 inserted into and secured in an upper end 110 of the support tube 11 and an upper end protruded from the support tube 11 and formed with an outer threaded portion 121 screwed into a lower portion of the inner threaded portion 131 of the mounting sleeve 13. The connecting member 12 of the main body 1 has a mediate portion formed with an annular stop flange 122 located between the lower end 120 and the outer threaded portion 121 and rested on the upper end 110 of the support tube 11 and a lower end of the mounting sleeve 13.

The housing 14 of the main body 1 is made of transparent material and has a hollow inside 140 to receive the light emitting device 2. The housing 14 of the main body 1 has a lower end formed with an outer threaded section 141 screwed into an upper portion of the inner threaded portion 131 of the mounting sleeve 13.

The main body 1 further includes a waterproof ring 142 mounted in the mounting sleeve 13 and located between the upper end of the connecting member 12 and the lower end of the housing 14 to provide a waterproof function between the connecting member 12, the housing 14 and the mounting sleeve 13.

The light emitting device 2 includes a protective unit 22 mounted in the housing 14 of the main body 1, a light emitting member 21 mounted in the protective unit 22, and two electric cords 211 connected to a distal end of the light emitting member 21 to provide en electric power to the light emitting member 21. The electric cords 211 are connected to a ballast 3 which is used to stabilize the voltage of the light emitting member 21.

The light emitting member 21 of the light emitting device 2 is preferably a luminescent tube.

The protective unit 22 of the light emitting device 2 includes a mounting tube 221 mounted in the housing 14 of the main body 1 to receive the light emitting member 21, an upper retainer 222 mounted on an upper end of the mounting tube 221 and clamped on an upper end of the light emitting member 21 to retain the light emitting member 21, and a lower retainer 223 mounted on a lower end of the mounting tube 221 and clamped on a lower end of the light emitting member 21 to retain the light emitting member 21. The mounting tube 221 of the protective unit 22 is made of transparent material. The upper retainer 222 of the protective unit 22 has a lower end inserted into the upper end of the mounting tube 221 and an upper end secured in the housing 14 of the main body 1 to prevent the mounting tube 221 from slipping from the housing 14 of the main body 1. The lower retainer 223 of the protective unit 22 has a lower end inserted into the upper end of the connecting member 12 and an upper end inserted into the lower end of the mounting tube 221. The lower retainer 223 of the protective unit 22 is located between the upper end of the connecting member 12 and the lower end of the housing 14 to position the light emitting device 2 in the main body 1.

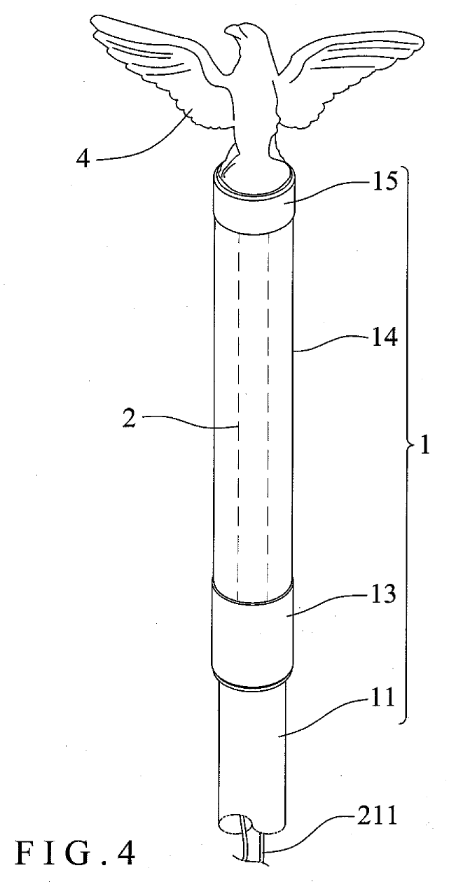

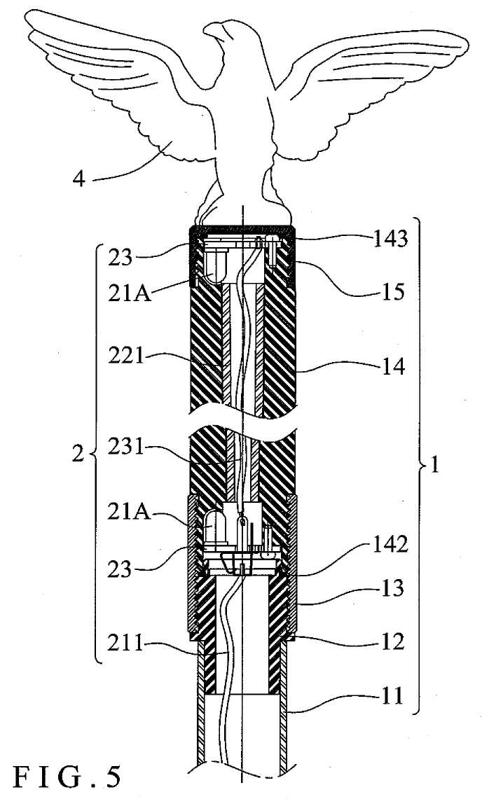

Referring to FIGS. 4 and 5, the housing 14 of the main body 1 has two open ends. The main body 1 further includes an end cap 15 mounted on an upper end of the housing 14 to cover the light emitting device 2, an ornament 4 mounted on a top of the end cap 15, and a waterproof ring 143 mounted in the end cap 15 and located between the end cap 15 and the upper end of the housing 14 to provide a waterproof function between the housing 14 and the end cap 15.

The light emitting device 2 includes a plurality of circuit boards 23 mounted in the housing 14 of the main body 1, a plurality of light emitting members 21A mounted on the circuit boards 23, a plurality of connecting wires 231 connected between the circuit boards 23, two electric cords 211 connected to one of the circuit boards 23 to provide en electric power to the light emitting members 21A, and a mounting tube 221 mounted in the housing 14 of the main body 1 and located between the circuit boards 23 to allow passage of the connecting wires 231. Each of the light emitting members 21A of the light emitting device 2 is preferably a light emitting diode (LED).

Accordingly, the guide comprises a light emitting device 2 that emits light outwardly to provide a warning effect at the night or on a darker place so as to provide the driver's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A guide, comprising a main body and a light emitting device mounted in the main body, wherein the main body includes
a support tube to support the light emitting device;
a connecting member mounted on the support tube;
a mounting sleeve mounted on the connecting member;
a housing mounted on the mounting sleeve and juxtaposed to the connecting member to retain the light emitting device between the housing and the connecting member.

2. The guide in accordance with claim 1, wherein
the mounting sleeve of the main body has an inside formed with an inner threaded portion;
the connecting member of the main body has a lower end inserted into and secured in an upper end of the support tube and an upper end protruded from the support tube and formed with an outer threaded portion screwed into a lower portion of the inner threaded portion of the mounting sleeve;
the housing of the main body has a lower end formed with an outer threaded section screwed into an upper portion of the inner threaded portion of the mounting sleeve.

3. The guide in accordance with claim 2, wherein the inner threaded portion of the mounting sleeve extends a whole length of the mounting sleeve of the main body.

4. The guide in accordance with claim 2, wherein the connecting member of the main body has a mediate portion formed with an annular stop flange located between the lower end and the outer threaded portion and rested on the upper end of the support tube and a lower end of the mounting sleeve.

5. The guide in accordance with claim 1, wherein the housing of the main body is made of transparent material.

6. The guide in accordance with claim 1, wherein the main body further includes a waterproof ring mounted in the mounting sleeve and located between the upper end of the connecting member and the lower end of the housing to provide a waterproof function between the connecting member, the housing and the mounting sleeve.

7. The guide in accordance with claim 1, wherein the light emitting device includes
a protective unit mounted in the housing of the main body;
a light emitting member mounted in the protective unit;
two electric cords connected to a distal end of the light emitting member to provide en electric power to the light emitting member.

8. The guide in accordance with claim 7, wherein the light emitting member of the light emitting device is a luminescent tube.

9. The guide in accordance with claim 7, wherein the light emitting member of the light emitting device is a light emitting diode.

10. The guide in accordance with claim 7, wherein the protective unit of the light emitting device includes
a mounting tube mounted in the housing of the main body to receive the light emitting member;
an upper retainer mounted on an upper end of the mounting tube and clamped on an upper end of the light emitting member to retain the light emitting member;
a lower retainer mounted on a lower end of the mounting tube and clamped on a lower end of the light emitting member to retain the light emitting member.

11. The guide in accordance with claim 10, wherein
the upper retainer of the protective unit has a lower end inserted into the upper end of the mounting tube and an upper end secured in the housing of the main body to prevent the mounting tube from slipping from the housing of the main body;
the lower retainer of the protective unit has a lower end inserted into the upper end of the connecting member and an upper end inserted into the lower end of the mounting tube;
the lower retainer of the protective unit is located between the upper end of the connecting member and the lower end of the housing to position the light emitting device in the main body.

12. The guide in accordance with claim 1, wherein
the housing of the main body has two open ends;
the main body further includes
an end cap mounted on an upper end of the housing to cover the light emitting device;
an ornament mounted on a top of the end cap;
a waterproof ring mounted in the end cap and located between the end cap and the upper end of the housing to provide a waterproof function between the housing and the end cap.

13. The guide in accordance with claim 1, wherein the light emitting device includes
a plurality of circuit boards mounted in the housing of the main body;
a plurality of light emitting members mounted on the circuit boards;
a plurality of connecting wires connected between the circuit boards;
two electric cords connected to one of the circuit boards to provide en electric power to the light emitting members;
a mounting tube mounted in the housing of the main body and located between the circuit boards to allow passage of the connecting wires.

14. The guide in accordance with claim 1, wherein the support tube of the main body has two open ends.

15. The guide in accordance with claim 1, wherein the mounting sleeve of the main body connects the connecting member and the housing.

16. The guide in accordance with claim 1, wherein the connecting member of the main body connects the support tube and the mounting sleeve.

17. The guide in accordance with claim 1, wherein the connecting member of the main body has a tubular shape.

18. The guide in accordance with claim 1, wherein the housing of the main body has a hollow inside to receive the light emitting device.

19. The guide in accordance with claim 1, wherein the mounting tube of the protective unit is made of transparent material.

20. The guide in accordance with claim 7, wherein the electric cords are connected to a ballast which is used to stabilize the voltage of the light emitting member.
